(19) United States
(12) Patent Application Publication
(10) Pub. No.: US 2010/0242057 A1
(43) Pub. Date: Sep. 23, 2010

(54) TRAVERSE OF LIGHT SCRIBE DISK DRIVE

(75) Inventors: Hsien-Chung OU, Taoyuan County (TW); Kuo-Hao She, Taoyuan County (TW); Shih-Jung Huang, Taoyuan County (TW)

Correspondence Address: RABIN & Berdo, PC, 1101 14TH STREET, NW, SUITE 500, WASHINGTON, DC, 20005, US

(73) Assignee: QUANTA STORAGE INC., Taoyuan County (TW)

(21) Appl. No.: 12/705,498

(22) Filed: Feb. 12, 2010

(30) Foreign Application Priority Data
Mar. 17, 2009 (TW) 98108704

(51) Int. Cl. G11B 19/20

(52) U.S. Cl. 720/696; G9B/7.042

(57) ABSTRACT

A traverse of a light scribe disk drive is provided. An opening is disposed at the center of a frame, wherein one end of the opening has a half circle, and a fillister is integrally formed around the half circle. A spindle motor is mounted on a PCB to form a spindle motor module. The PCB with a connecting slot is disposed on the frame to insert the spindle motor into the half circle. An optical sensor is mounted on a substrate to form an optical sensor module, and the substrate is inserted in the fillister. One end of a cable is connected to the substrate, and the other end is connected to the connecting breach to simplify the structure.

This application claims the benefit of Taiwan application Serial No. 98108704, filed Mar. 17, 2009, the subject matter of which is incorporated herein by reference.

### BACKGROUND OF THE INVENTION

1. Field of the Invention

The invention relates in general to a traverse of a disk drive, and more particularly to a traverse of a light scribe disk drive, which directly scribes a label on the label side of an optical disk with the laser beam emitted from the pick-up head.

2. Description of the Related Art

The light scribe disk drive directly scribes the image text on the label side of an optical disk to form the label of the optical disk by the laser etching technology, and is free of the problems such as ink stain, label curliness and attachment which may occur to ordinary paper printing or labeling.

As indicated in FIG. 1, a sectional view of a traverse 1 of a light scribe disk drive disclosed in U.S. Pat. No. 7,334,245 is shown. The traverse 1 fixes the spindle motor 3 connected to the printed circuit board (PCB) 2 on the frame 4 to rotate an optical disk 5. One side of the optical disk 5 is a data side 6 on which data are recorded, and the other side is a label side 7 on which image texts are scribed. The inner ring of the optical disk 5 has a ring of bar code 8 consisting of 400 bars used for indicating the azimuth angle of the label side 7. The traverse 1 further reads the bar code 8 to position the azimuth angle of label side 7 with the optical sensing module 9. As the frame 4 is too close to the optical disk 5, the optical sensing module 9 cannot be directly mounted on the frame 4 near the peripheral of the spindle motor 3. Normally, a through hole 10 is formed on the frame 4 right under the bar code 8, and the rubber pad 11 disposed on the PCB 2 of the spindle motor 3 is placed under the substrate 12 of the optical sensing module 9 to increase the height of the optical sensing module 9, so that the optical sensor 13 of the optical sensing module 9 can enter the through hole 10 to read the bar code 8. The optical sensing module 9 further transmits power and signal through the cable 14 connected to the substrate 12 to the PCB 2 of the spindle motor 3.

Although the traverse 1 uses the rubber pad 11 to pad the optical sensing module 9 higher and isolate the circuit of the optical sensing module 9 which may affect the PCB 2, the rubber pad 11 disposed on the PCB 2 still may impede the circuit arrangement of the PCB 2. Thus, the foregoing patent provides an invention which supports the optical sensing module 9 by a fixing piece and directly fastens the fixing piece on the frame 4 with a bolt. However, the structure of supporting the optical sensing module by the fixing piece is not a simple structure and cannot reduces the manufacturing cost. Furthermore, to form a through hole 10 on the frame 4 of the spindle motor 3 which is rotated at a high speed reduces the structural strength of the frame 4 of the traverse and affects the rotation stability of the spindle motor 3. Moreover, the fixing piece, which is fastened by one side only, may move easily so as to affect the positioning accuracy of the optical sensing module 9 and result in errors in reading the bar code. Thus, the generally known traverse of the light scribe disk drive still has many problems to resolve in terms of the structure of fixing the optical sensing module.

### SUMMARY OF THE INVENTION

According to a first aspect of the present invention, a traverse of a light scribe disk drive is provided. A fillister is directly formed on the frame of the traverse for fastening the optical sensing module in the fillister to strengthen the frame of the traverse and simply the structure.

According to a second aspect of the present invention, a traverse of a light scribe disk drive is provided. A fillister goes with the peripheral shape of the optical sensing module, and the side wall of the fillister limits the fixing direction of the optical sensing module, so that the assembly is made easier and the accuracy in positioning is increased.

According to a third aspect of the present invention, a traverse of a light scribe disk drive is provided. A fixing block is disposed in the fillister for holding the substrate of the optical sensing module, and the hook slot disposed on a lateral side of the substrate facilitates the disassembly of the traverse of the light scribe disk drive.

According to a fourth aspect of the present invention, a traverse of a light scribe disk drive is provided. Two positioning columns are disposed in the fillister, and two positioning holes corresponding to the two positioning columns are disposed on the substrate. Despite the peripheral shape is not matching, the substrate still can be easily assembled and fastened, hence expanding the flexibility in the application of the fillister.

According to a fifth aspect of the present invention, a traverse of a light scribe disk drive is provided. A positioning column and a locking hole are disposed in the fillister, and a positioning hole and a screw hole respectively corresponding to the positioning column and the locking hole are disposed on the substrate. Despite the peripheral shape is not matching, the substrate still can be easily assembled and fastened to limit the fixing direction of the optical sensing module.

In order to achieve the above objects, a traverse of a light scribe disk drive is provided. An opening is disposed at the center of a frame, wherein one end of the opening has a half circle, and a fillister is integrally formed around the half circle. A spindle motor is mounted on a PCB to form a spindle motor module. The PCB with a connecting slot is disposed on the frame to insert the spindle motor into the half circle. An optical sensor is mounted on a substrate to form an optical sensor module, and the substrate is inserted in the fillister. One end of the cable is connected to the substrate, and the other end is connected to the connecting slot to simplify the structure.

According to the traverse of the light scribe disk drive of the invention, the peripheral shape of the substrate matches with that of the fillister in terms of positioning, and a hook slot is disposed on one lateral side of the substrate, so that the substrate can be conveniently detached from the fillister. A channel connecting the opening is formed on one side of the fillister, one end of the cable is connected to one side of the substrate, and the other end has a soldering point. The cable is soldered to the connecting slot near the channel through the channel. The substrate can be adhered in the fillister by a double-side adhesive tape, and the fixing blocks are protruded from at least two side walls of the fillister for engaging the substrate in the fillister.

According to the traverse of the light scribe disk drive of another embodiment of the invention, two positioning columns are disposed on the bottom of the fillister, and two positioning holes corresponding to the two positioning columns are disposed on the substrate so that the two positioning columns enter the two positioning holes to position the optical sensing module. Or, a positioning column and a screw hole are disposed on the bottom of the fillister, and a positioning hole and a locking hole respectively corresponding to the positioning column and the screw hole are disposed on the substrate so that the positioning column enter the positioning hole and a bolt passes through the locking hole to be screwed in the screw hole to fasten the substrate in the fillister.

The invention will become apparent from the following detailed description of the preferred but non-limiting embodiments. The following description is made with reference to the accompanying drawings.

### BRIEF DESCRIPTION OF THE DRAWINGS

FIG. 1 (prior art) shows a sectional view of a traverse of a light scribe disk drive;

FIG. 2 shows a top view of a light scribe disk drive of the invention;

FIG. 3 shows an explosion diagram of the traverse of a first embodiment of the invention;

FIG. 4 shows a front 3-D diagram of the traverse of the first embodiment of the invention;

FIG. 5 shows a rear 3-D diagram of the traverse of the first embodiment of the invention;

FIG. 6 shows an explosion diagram of a traverse of a second embodiment of the invention;

FIG. 7 shows an explosion diagram of a traverse of a third embodiment of the invention; and

FIG. 8 shows an explosion diagram of a traverse of a fourth embodiment of the invention.

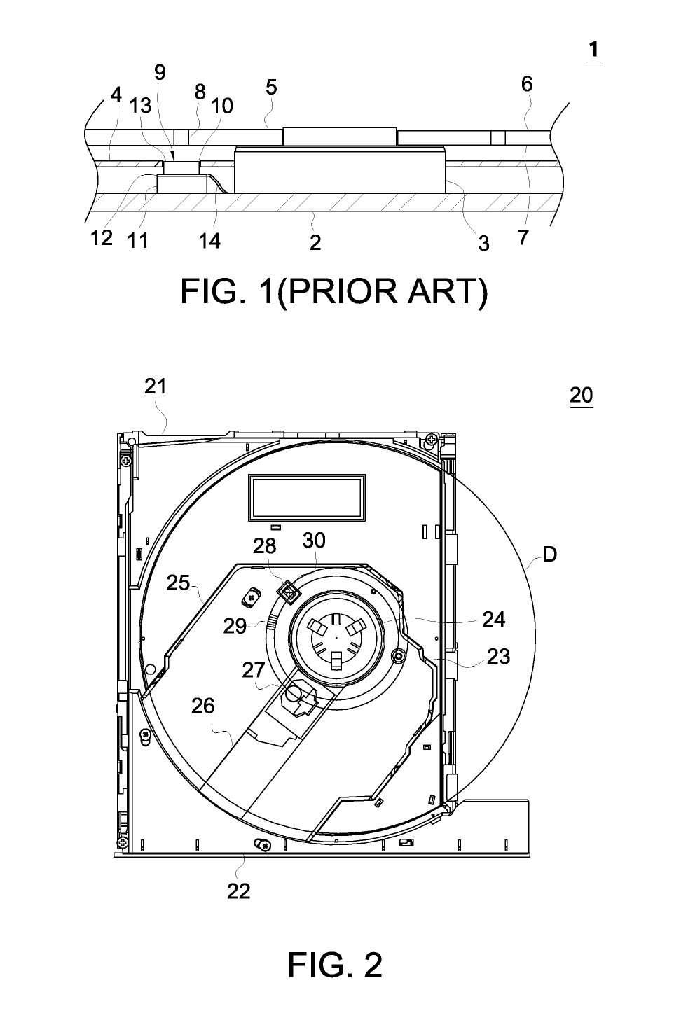

### DETAILED DESCRIPTION OF THE INVENTION

The technologies, methods and effects for achieving the above objects of the invention are disclosed in a number of preferred embodiments with accompanying drawing and disclosures.

Referring to FIG. 2, a top view of a light scribe disk drive 20 of the invention is shown. On the part of the light scribe disk drive 20, a tray 22 can slide into or from the interior of a hollowed housing 21. A traverse 23 is disposed in the tray 22, and a spindle motor module 24 is disposed on one end of the traverse 23 and located at the center of the tray 22. A thin protection piece 25 is coated on the traverse 23 and around the spindle motor module 24. A long groove 26 is disposed along the radial direction of the spindle motor module 24 for the pick-up head 27 to slide back and forth. The protection piece 25 averts the long groove 26 of the pick-up head 27, and a squared hole 28 is disposed on the peripheral of the spindle motor module 24 and aligned with a bar code 29 of the optical disk D to expose the optical sensing module 30.

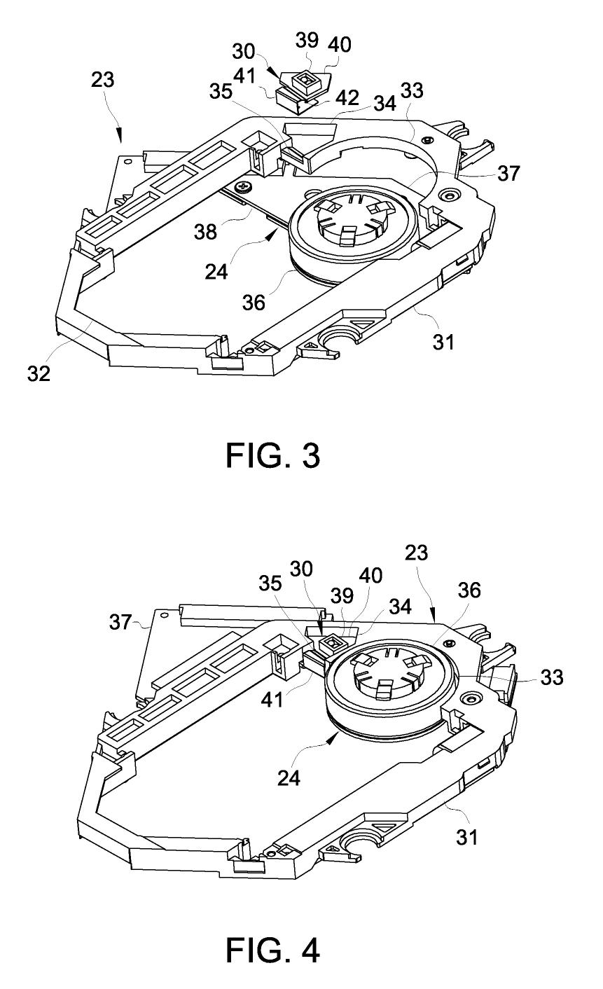

As indicated in FIG. 3, the structure of the traverse 23 of the light scribe disk drive of the first embodiment of the invention with a protection piece being lifted is shown. The traverse 23 mainly includes a frame 31, a spindle motor module 24 and an optical sensing module 30. An opening 32 is disposed at the center of the frame 31, and one end of the opening 32 has a half circle 33. A fillister 34 is integrally formed on the peripheral of the frame 31 and around the half circle 33 whose radius equal to the bar code. The fillister 34 has a pre-determined peripheral shape. A channel 35 connecting the opening 32 is formed on the fillister 34 near an edge of the opening 32. The spindle motor module 24 includes a spindle motor 36 and a PCB 37. The spindle motor 36 is integrally mounted on the PCB 37. The PCB 37 transmits power and a controlling signal to the spindle motor 36. A connecting slot 38 is formed on the PCB 37 near the channel 35.

The optical sensing module 30 includes an optical sensor 39, a substrate 40 and a cable 41. The optical sensor 39 is integrally mounted on the substrate 40. The peripheral shape of the substrate 40 match with that of the fillister 34, and their shapes can be identical or mutually positioned, and a flexible cable 41 is connected to one side of the substrate 40 opposite to the channel 35. A soldering point 42 is disposed on the extension end of the cable 41. The substrate 40 transmits power and signals to the optical sensor 39 through the cable 41.

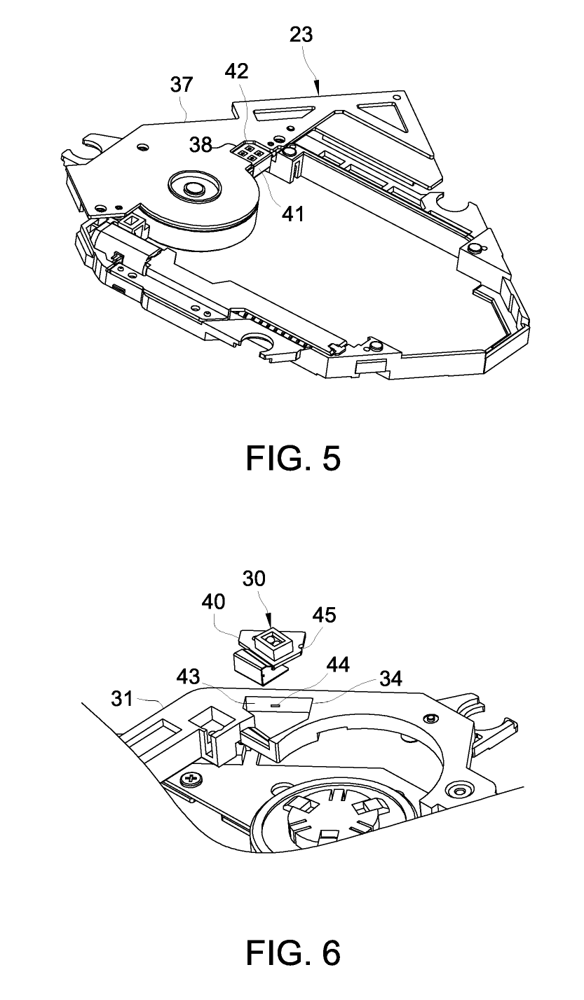

As indicated in FIG. 4 and FIG. 5, the front view and the rear view of an assembly structure of the traverse of the light scribe disk drive 23 of the first embodiment of the invention are shown. When assembling the optical sensing module 30, firstly, the spindle motor 36 of the spindle motor module 24 is inserted into the half circle 33 of the frame 31. Next, the PCB 37 is fastened on the frame 31 of the traverse 23, so that the spindle motor 36 is automatically aligned with the center of the half circle 33. Then, an adhesive or a double-side adhesive tape is coated in the fillister 34 or on the substrate 40 for placing the optical sensor 39 upward and directing the cable 41 towards the channel 35, and the substrate 40 is inserted into the fillister 34 along the side wall of the fillister 34 with the peripheral shape of the substrate 40 matching with that of the fillister 34. As the adhering direction of the substrate 40 is limited and supported by the side wall of the fillister 34, it is assured that the optical sensor 39 is aligned with the direction of the bar code. Afterwards, the cable 41 is pulled out along the channel 35, and the soldering point 42 is soldered on the connecting slot 38 of the PCB 37. Thus, the assembly of the optical sensing module 30 is promptly completed.

According to the traverse of the light scribe disk drive of the first embodiment of the invention, the fillister is formed on the frame of the traverse for fixing and supporting the optical sensing module to read the bar code. As the frame of the traverse is not hollowed, the structural strength will not be weakened. Furthermore, the side wall of the fillister enhances the structural strength of the frame of the traverse and makes the spindle motor even more stabilized during high-speed rotation. The fillister is integrally formed on the optical sensing module without using any fixing piece, hence reducing the number of the parts, simplifying the structure, and further reducing the manufacturing cost. Besides, the fillister of the traverse of the light scribe disk drive of the first embodiment of the invention matches with the peripheral shape of the substrate of the optical sensing module and limits the fixing direction of the optical sensing module by the side wall of the fillister, not only providing easy assembly but also enabling the optical sensing module to have higher accuracy in positioning.

The traverse of the light scribe disk drive of the first embodiment of the invention fixes the optical sensing module by way of adhering. However, the optical sensing module is not limited to be fixed by way of adhering. As indicated in FIG. 6, an explosion diagram of a traverse of a second embodiment of the invention is shown. The structure of the traverse of the light scribe disk drive of the second embodiment is basically similar to that of the first embodiment. To simplify the elaboration, the same designations are used for the same elements. The second embodiment mainly differs with the first embodiment in the fillister 34. A fixing block 44 is disposed on each of at least two side walls 43. When the substrate 40 is inserted into the fillister 34 by the elasticity of the frame 31 and the substrate 40, the fixing block 44 blocks the upper edge of the substrate 40 to fix the optical sensing module 30. Also, a hook slot 45 is indented into one lateral side of the substrate 40, so that the substrate 40 can be detached from the fillister 34 conveniently due to the hook slot 45, hence achieving the object of prompt disassembly and resolving the difficulty in disassembling which occurs when adhesion method of fixing is adopted.

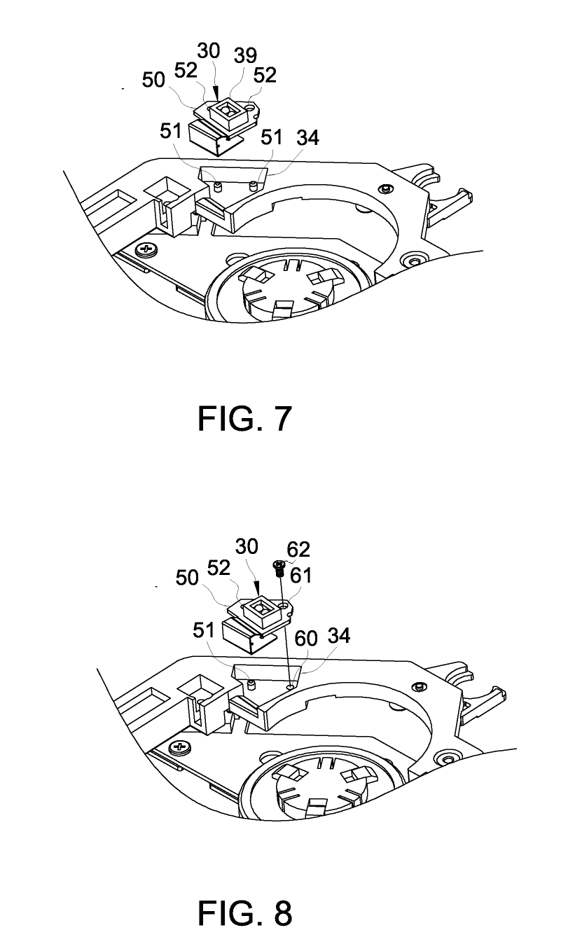

As indicated in FIG. 7, an explosion diagram of a traverse of a third embodiment of the invention is shown. The basic structure of the third embodiment is basically similar to that of the first embodiment. To simplify the elaboration, the same designations are used for the same elements. The third embodiment mainly differs with the first embodiment in the fillister 34 and the substrate 50. The peripheral shape of the substrate 50 does not match that of the fillister 34. Two positioning columns 51 are projected from the bottom of the fillister 34, and two positioning holes 52 are disposed on the part of the substrate 50 corresponding to the two positioning columns 51. When the substrate 50 is inserted into the fillister 34, the positioning columns 51 enter the positioning holes 52, and the substrate 50 is fixed in the fillister 34 by way of adhering or engaging as disclosed in the above embodiment. Despite the peripheral shape of the substrate 50 does not match that of the fillister 34, the optical sensor 39 fixed on the substrate 50 is promptly positioned and aligned with the optical disk bar code. Thus, the traverse of the light scribe disk drive of the present embodiment of the invention, replaces the mechanism of positioning limiting by mutually matched peripheral shapes with the mechanism of the positioning columns 51 and the positioning holes 52, so that the fillister 34 can be adapted to the optical sensing module 30 of various makes and the flexibility of application is further expanded.

As indicated in FIG. 8, an explosion diagram of a traverse of a fourth embodiment of the invention is shown. The basic structure of the fourth embodiment is basically similar to that of the first embodiment and developed from the third embodiment. To simplify the elaboration of the invention, the same designations are used for the same elements. The main differences are that, in the fourth embodiment, a positioning column 51 projected from the bottom of the fillister 34 is changed to a screw hole 60, and the positioning hole located at the part of the substrate 50 corresponding to the screw hole 60 is changed to a locking hole 61. When the substrate 50 is inserted into the fillister 34, the positioning column 51 enters the positioning hole 52, and then a bolt 62 passing through the locking hole 61 to be screwed in the screw hole 60, fastens the substrate 50 in the fillister 34. Although the peripheral shape of the substrate 50 does not match that of the fillister 34, the optical sensing module 30 still can be promptly fixed through the positioning column 51 and the bolt 62.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A traverse of a light scribe disk drive used for reading a bar code of an optical disk, wherein the traverse comprises:
a frame, wherein an opening is disposed at the center of the frame, one end of the opening has a half circle, and a fillister is integrally formed around the half circle;
a spindle motor module, wherein a spindle motor is mounted on a PCB, which has a connecting slot and is disposed on the frame to insert the spindle motor into the half circle; and
an optical sensing module, wherein an optical sensor is mounted on a substrate to insert the substrate in the fillister, so that the optical sensor is aligned with the bar code, one end of a cable is connected to the substrate, and the other end is connected to the connecting slot.

2. The traverse of the light scribe disk drive according to claim 1, wherein the substrate is fixed in the fillister by way of adhering.

3. The traverse of the light scribe disk drive according to claim 2, wherein the substrate is fixed in the fillister by a double-side adhesive tape.

4. The traverse of the light scribe disk drive according to claim 1, wherein one side of the fillister has a channel for connecting the opening, the connecting slot is disposed near the channel, one end of the cable is connected to one side of the substrate opposite to the channel, and the other end is connected to the connecting slot through the channel.

5. The traverse of the light scribe disk drive according to claim 4, wherein one end of the cable connected to the connecting slot has a soldering point for fixing the cable on the connecting slot.

6. The traverse of the light scribe disk drive according to claim 1, wherein the peripheral shape of the substrate and that of the fillister are mutually matched for positioning.

7. The traverse of the light scribe disk drive according to claim 6, wherein the substrate and the fillister have identical peripheral shape.

8. The traverse of the light scribe disk drive according to claim 6, wherein a plurality of fixing blocks are projected from at least two side walls of the fillister for engaging the substrate in the fillister.

9. The traverse of the light scribe disk drive according to claim 1, wherein a hook slot is disposed on one lateral side of the substrate so that the substrate is conveniently detached from the fillister.

10. The traverse of the light scribe disk drive according to claim 1, wherein two positioning columns are disposed on the bottom of the fillister, and two positioning holes corresponding to the two positioning columns are disposed on the substrate so that the two positioning columns enter the two positioning holes to position the optical sensing module.

11. The traverse of the light scribe disk drive according to claim 1, wherein a positioning column and a screw hole are disposed on the bottom of the fillister, and a positioning hole and a locking hole respectively corresponding to the positioning column and the screw hole are disposed on the substrate so that the positioning column enter the positioning hole and a bolt passes through the locking hole to be screwed in the screw hole to fasten the substrate in the fillister.
